(19) United States
(12) Patent Application Publication
(10) Pub. No.: US 2022/0408967 A1
(43) Pub. Date: Dec. 29, 2022

(54) Segmented Porous Barbeque Grill Grate

(71) Applicant: American Heating Technologies Inc., Los Angeles, CA (US)

(72) Inventors: Raymond Vartanian, Glendale, CA (US); Armond Vartanian, Glendale, CA (US)

(21) Appl. No.: 17/809,542

(22) Filed: Jun. 28, 2022

Related U.S. Application Data
(60) Provisional application No. 63/202,879, filed on Jun. 28, 2021.

(51) Int. Cl. A47J 37/06; A47J 37/07

(52) U.S. Cl. CPC A47J 37/0694; A47J 37/0786

(57) ABSTRACT

The apparatus is a porous barbeque grill grate. The apparatus incorporates slats that have two sides which hold together porous ceramic plates. The plates can be segmented in some embodiments. The slats are then configured next to one another in some angled differential. The configured slats are then incorporated onto a front and back plates to secure the apparatus unto a gas grill at some distance away from the grill's burner. The segmented porous barbeque grill grate provides for a steady thermal environment, distributing heat evenly, providing a steady flow of oxygen and allowing fuel to uniformly burn and allow flavor and aroma to rise up and be infused with the food that is being grilled or cooked.

### PRIORITY CLAIMS AND CROSS-REFERENCE TO RELATED APPLICATIONS

This application is related to and claims domestic priority benefits under 35 USC § 119(e) from U.S. Provisional Patent Application Ser. No. 63/202,879 filed on Jun. 28, 2021, the entire contents, of the aforementioned application, are expressly incorporated hereinto by reference.

### BACKGROUND

Many barbeque technologies exist to provide the user an ability to evenly grill the desired cut of meat. Moreover, these technologies allow one to “replicate” the flavor and aroma of meat otherwise found when grilling on a charcoal or wood grill, by using a gas-powered grill instead.

With gas grills, some systems employ evenly spaced ceramic briquettes to allow proper distribution of the heat while grilling. These briquettes may also be geometrically designed such that when the juices or liquids from the meat fall on them, the juices and liquids quickly burn and sizzle. This produces an aroma and flavor mimicking the aroma and flavor found on meat grilled on a charcoal or wood fired grill. The aroma and thus the flavor, is transferred unto the meat as the sizzled and burned vapors or smoke rise up and come into contact with the meat.

The disclosure here thus deals with the field of gas barbeque grills and grill grates.

### SUMMARY

In accordance with an aspect of this disclosure, there is provided an apparatus that includes, a set of front and back plates, at least one set of supports and at least one porous plate.

Furthermore, the at least one porous plate is suspended in between the at least one set of supports.

Further still, a multiple of the at least one set of supports suspending the at least one porous plate are staggered against one another at a fixed angle.

Moreover, the multiple of the at least one set of supports suspending the at least one porous plate are affixed unto the set of the front and back plates.

Additionally, the fixed angle between the multiple of the at least one set of supports is can be 90 degrees or in between 45-90 degrees.

Finally, there can be seven of the at least one set of supports suspending the at the at least one porous plate.

### DESCRIPTION OF THE DRAWINGS

Embodiments in accordance with the present invention are shown in the drawings and will be described below with reference to the figures, whereby elements having the same effect have been provided with the same reference numerals. The following is shown:

FIG. 1A shows a perspective schematic view of the segmented porous barbeque grill grate apparatus described herein;

FIG. 2 shows a perspective view of an embodiment of the segmented porous barbeque grill grate;

FIG. 3 a side view of the segmented porous barbeque grill grate;

FIG. 4 is a front view of the segmented porous barbeque grill grate; and

FIG. 5 depicts the segmented porous barbeque grill grate from a top view.

### DESCRIPTION

The present apparatus is composed of a metallic frame that encapsulates a plurality of porous ceramic plates. In this disclosure the apparatus is not limited to gas barbeque grills and can be implemented on a gas appliance, a gas oven, a gas grill or the like.

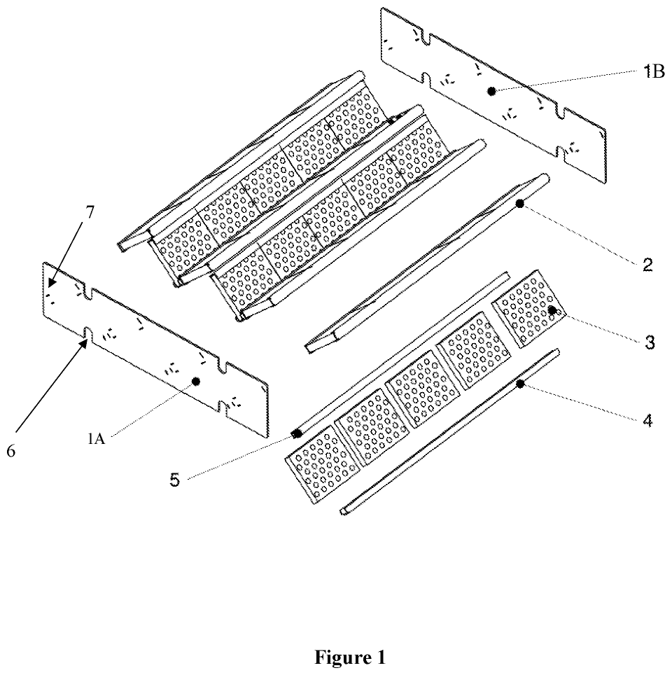

In FIG. 1, the present apparatus is described in an exploded perspective view. It is projected that this apparatus and its ancillary components can be fitted into a gas grill of various sizes or configurations. Thus, these illustrations are exemplary and should not be limited it to particular size or shape.

Thus, FIG. 1 exemplifies an embodiment of the segmented porous barbeque grill grate. The apparatus incorporates front and back plates 1A and 1B, respectively. The front and back plates 1A and 1B may be made of a sturdy material such as metal, ceramic, glass, steel or some metallic alloy. The front and back plates, 1A and 1B may have segmented holes and grooves where by the plates 1A and 1B can attach to other components and ultimately be integrated into a gas grill. Exemplary holes are shown by 7 and the grooves are illustrated by 6.

In one configuration, the holes 7 are used to attach the set of ceramic supports 4 and 5 (generally known as set of supports) running between the front and back plates 1A and 1B. In this embodiment, seven sets of holes 7 are indicated on each of the plates 1A and 1B, although it is not limited to this number or configuration. In other embodiments, these holes 7, can be substituted with rivets or the set of ceramic supports 4 and 5 can be secured unto the front and back plates 1A and 1B with spot welding. Thus, the holes 7 may be temporary placements indicating patterns whereby the set of ceramic supports 4 and 5 can be configured on and in between the front and back plates 1A and 1B.

In addition to these holes 7, the front and back plates 1A and 1B have grooves 6, where the whole apparatus can rest on top of a gas grill's burners. In some embodiments, the grooves 6 mate with a detent on the gas grill's internal cavity, thereby suspending the apparatus some distance away from the gas grill's burners (not pictured). Also, the grooves 6 are located both at the top and bottom of the front and back plates 1A and 1B, such that the user can turn the whole segmented porous barbeque grill grate from one side and unto the other. This gives the user the ability to turn the segmented porous barbeque grill grate on one side at one cooking session and then flipping it at its underside at another cooking session. This conversion allows the user to conduct a “self-clean” of the apparatus by exposing the underside of the surface of the apparatus to the burner where any remaining residue can burn away.

The set of ceramic supports 4 and 5 are paired together in order to hold the porous ceramic plates 3 (generally known as porous plates) in place. In some embodiments, segmented multiple porous ceramic plates 3 can be inserted in between a set of ceramic supports 4 and 5 and in some embodiments, a single continuous porous ceramic plates 3 can be held in place and in between the set of ceramic supports 4 and 5. The porous ceramic plates 3 are held in place by retaining walls incorporated within the set of ceramic supports 4 and 5. Moreover, the finally constructed structures that includes the porous ceramic plates 3 and the set of ceramic supports 4 and 5 is installed or affixed unto the front and back plates 1A and 1B. It is worthy to note that the porous ceramic plates 3 can be made of various types of materials such as ceramic, clay, hardened glass, composite material, metal or a metal alloy. Thus, the term porous ceramic plate is to be used broadly to encompass various material compositions.

These slats (combination of the porous ceramic plates 3 inserted into and in between the set of ceramic supports 4 and 5) are shown in one embodiment to have a pattern of a staggered and sequential orientation where on slat is at a 90-degree angle to the one that follows it, so on and so forth until seven (although, it is not limited to this number, configuration or degree of orientation) of these slats are installed. This configuration distributes the heat evenly throughout the top surface of the gas grill. Furthermore, the porous ceramic plates 3 allow for oxygen to flow into the system in an even fashion while at the same time allowing for any fallen juices or liquids to completely burn rather than allowing some juices or liquids to pass through the holes and unto the burner. This aids the gas grill's burner in staying clean and providing a steady flame output at each cooking session. It is projected that other angled configurations are also possible and these disclosures are not to be limited as such.

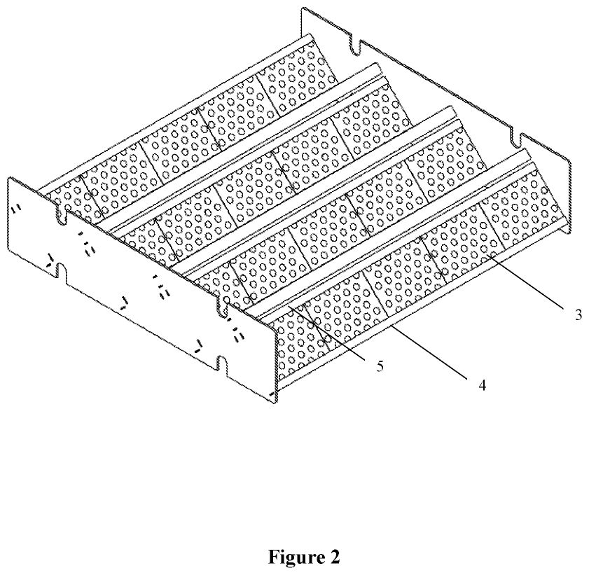

In FIG. 2, shows a perspective view of an embodiment of the segmented porous barbeque grill grate is shown assembled as a single unit that can be installed unto a gas grill. As can be seen, the segmented ceramic plates 3 are placed, one another, in between the set of ceramic supports 4 and 5.

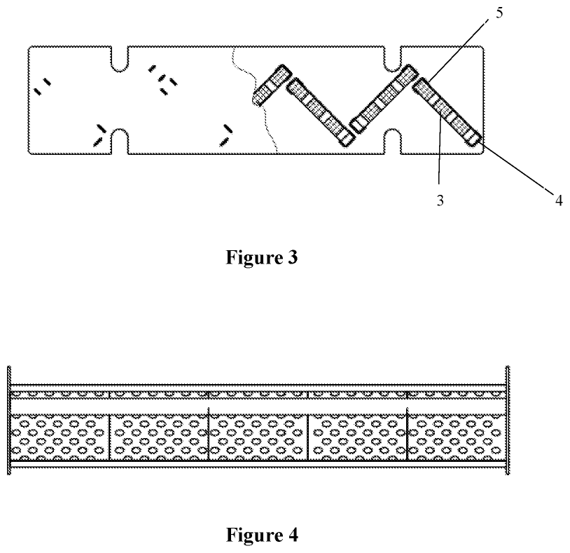

FIG. 3 is a side view of the segmented porous barbeque grill grate partially showing a cross section of the ceramic plates 3 as they are placed in between a set of ceramic supports 4 and 5. Moreover, as can be seen from the illustration, are the slats that are placed in a configuration that provides a 90-degree angle in between the pairs of seven (or other number configuration, or degree of orientation) slats.

FIG. 4 is a front view of the segmented porous barbeque grill grate. The component of the segmented porous barbeque grill grate has already been discussed and need not be done so here again.

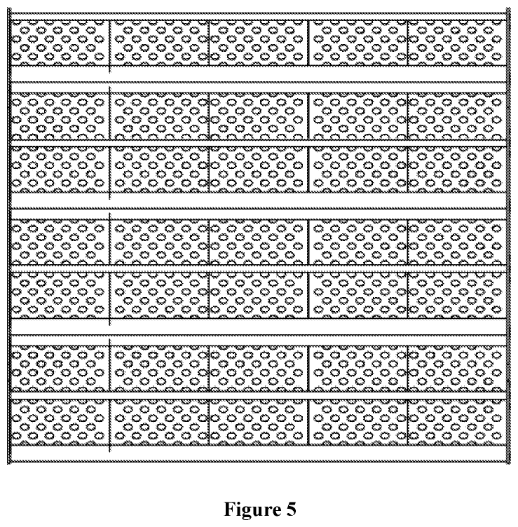

FIG. 5 depicts the segmented porous barbeque grill grate from a top view. This shows the slats that are placed against one another and affixed unto the front and back plates 1A and 1B at an angle that makes up the whole apparatus.

Although the present disclosure has been described in considerable detail with reference to certain embodiments thereof, other embodiments are possible. Therefore, the scope of the appended claims should not be limited to the description of the embodiments contained herein.

What is claimed is:

1. A porous grill grate comprising:
a set of front and back plates;
at least one set of supports; and
at least one porous plate.

2. The porous grill grate of claim 1, wherein the at least one porous plate is suspended in between the at least one set of supports.

3. The porous grill grate of claim 2, wherein a multiple of the at least one set of supports suspending the at least one porous plate are staggered against one another at a fixed angle.

4. The porous grill grate of claim 3, wherein the multiple of the at least one set of supports suspending the at least one porous plate are affixed unto the set of the front and back plates.

5. The porous grill grate of claim 3, wherein the fixed angle between the multiple of the at least one set of supports is 90 degrees.

6. The porous grill grate of claim 3, wherein the fixed angle between the multiple of the at least one set of supports is between 45 and 90 degrees.

7. The porous grill grate of claim 5, wherein there are seven of the at least one set of supports suspending the at the at least one porous plate.
